(19) United States
(12) Patent Application Publication
(10) Pub. No.: US 2021/0387744 A1
(43) Pub. Date: Dec. 16, 2021

(54) UNMANNED AERIAL VEHICLE (UAV) LAUNCHING ASSEMBLY FOR MONITORED AND STABLE LAUNCHING OF UAVS

(71) Applicant: IRON DRONE LTD., Tel Aviv (IL)

(72) Inventors: Matan MELAMED, Tel Aviv (IL); Ishai DORON, Tel Aviv (IL); Stanislav YASINOV, Tel Aviv (IL)

(73) Assignee: IRON DRONE LTD., Tel Aviv (IL)

(21) Appl. No.: 17/143,604

(22) Filed: Jan. 7, 2021

Related U.S. Application Data
(60) Provisional application No. 62/958,413, filed on Jan. 8, 2020.

(51) Int. Cl. B64F 1/04; B64C 39/02

(52) U.S. Cl. CPC B64F 1/04; B64C 2201/088; B64C 2201/027; B64C 39/024

(57) ABSTRACT

An unmanned aerial vehicle (UAV) launching assembly for monitored and stable launching of UAVs is provided. The assembly includes a container having an open upper end and a bottom end separated by a distance, wherein the container is adapted to accept therein at least one UAV; and at least one fixture extending from the bottom end of the container towards the open upper end of the container, wherein the at least one fixture extends to at least a height equal to the distance separating the bottom end of the container from the open upper end of the container, wherein the at least one fixture is adapted to be accepted by at least one corresponding element of the at least one UAV, and wherein the at least one fixture is adapted to allow vertical motion of the at least one UAV within the container.

### CROSS-REFERENCE TO RELATED APPLICATIONS

This application claims the benefit of U.S. Provisional Application No. 62/958,413 filed on Jan. 8, 2020, the contents of which are hereby incorporated by reference.

### TECHNICAL FIELD

The present disclosure generally relates to launching systems for unmanned aerial vehicles (UAVs) and, more specifically, to a launcher assembly for monitored and stable launching of UAVs.

### BACKGROUND

An unmanned aerial vehicle (UAV), such as a drone, is an aircraft without a human pilot on board. Today, UAVs are used for many purposes, such as delivering goods, filming movies, guarding high-sensitivity areas, gathering intelligence, military strikes, and the like.

Generally, UAVs are launched from a launching surface. Conventionally, the UAVs may be stored or carried within a container before a UAV is set on a surface and throttled up for takeoff via a launching system.

However, one disadvantage of known launching systems is that, using these known systems, the UAV may not be launched from the storage container directly into flight in an accurate, safe, fast, and stable manner while keeping the UAV in its original shape and posture such that the UAV would be ready to execute its mission from the first second the UAV is launched from the container.

Using the known launching systems may also prevent the UAV from being suitable for certain applications, such as in a land vehicle, or other moving vehicles, where it may be desirable to launch the UAV into flight during movement of the vehicle.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the terms “some embodiments” or “certain embodiments” may be used herein to refer to a single embodiment or multiple embodiments of the disclosure.

Certain embodiments disclosed herein include an unmanned aerial vehicle (UAV) launching assembly for monitored and stable launching of UAVs. The assembly comprises: a container having an open upper end and a bottom end, wherein the container is adapted to accept therein at least one UAV, wherein the bottom end is separated from the open upper end by a distance; and at least one fixture extending from the bottom end of the container towards the open upper end of the container, wherein the at least one fixture extends to at least a height equal to the distance separating the bottom end of the container from the open upper end of the container, wherein the at least one fixture is adapted to be accepted by at least one corresponding element of the at least one UAV, and wherein the at least one fixture is adapted to allow vertical motion of the at least one UAV within the container.

Certain embodiments disclosed herein also include an unmanned aerial vehicle (UAV) for use with a UAV launcher assembly that comprises a container and at least one fixture extending therein. The UAV comprises: at least one element adapted to accept the at least one fixture of the UAV launcher assembly, wherein the at least one element is further adapted to permit motion of the UAV within the UAV launcher assembly about the at least one fixture.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1A is a cross-sectional front view of an unmanned aerial vehicle (UAV) launcher assembly, according to an embodiment.

FIG. 1B is a cross-sectional front view of an unmanned aerial vehicle (UAV) launcher assembly that contains a single UAV, according to an embodiment.

FIG. 1C is an isometric view of an unmanned aerial vehicle (UAV) launcher assembly showing hidden features, according to an embodiment.

FIG. 1D is an isometric view of an unmanned aerial vehicle (UAV) launcher assembly that contains a single UAV showing hidden features, according to an embodiment.

FIG. 1E is a top view of an unmanned aerial vehicle (UAV) launcher assembly, according to an embodiment.

FIG. 1F is a top view of an unmanned aerial vehicle (UAV) launcher assembly that contains a single UAV, according to an embodiment.

FIG. 2A is a cross-sectional front view of an unmanned aerial vehicle (UAV) launcher assembly that contains multiple UAVs, according to an embodiment.

FIG. 2B is an isometric view of an unmanned aerial vehicle (UAV) launcher assembly that contains multiple UAVs showing hidden features, according to an embodiment.

FIG. 3 is an isometric view of an unmanned aerial vehicle (UAV) for use with a UAV launcher assembly that comprises a container and fixtures extending therein, according to an embodiment.

FIG. 4A is a cross-sectional isometric view of an unmanned aerial vehicle (UAV) launcher assembly having two square guide rails and showing hidden features, according to an embodiment.

FIG. 4B is a top view of an unmanned aerial vehicle (UAV) launcher assembly having two square guide rails, according to an embodiment.

FIG. 4C is an isometric view of an unmanned aerial vehicle (UAV) launcher assembly, having two square guide rails, that contains a single UAV, showing hidden features, according to an embodiment.

FIG. 4D is a top view of an unmanned aerial vehicle (UAV) launcher assembly, having two square guide rails, that contains one or more UAVs, according to an embodiment.

FIG. 4E is a cross-sectional isometric view of an unmanned aerial vehicle (UAV) launcher assembly, having two square guide rails, that contains multiple UAVs, showing hidden features, according to an embodiment.

FIG. 4F is an isometric view of an unmanned aerial vehicle (UAV) having two slots for use with a UAV launcher assembly that comprises a container and at least one fixture extending therein, according to an embodiment.

FIG. 5A is an isometric view of an unmanned aerial vehicle (UAV) launcher assembly, having a single square guide rail, that contains a single UAV, showing hidden features, according to an embodiment.

FIG. 5B is a cross-sectional front view of an unmanned aerial vehicle (UAV) launcher assembly, having a single square guide rail, that contains a single UAV, according to an embodiment.

FIG. 5C is a top view of an unmanned aerial vehicle (UAV) launcher assembly, having a single square guide rail, that contains a single UAV, according to an embodiment.

FIG. 6A is an isometric view of an unmanned aerial vehicle (UAV) launcher assembly that contains a single UAV that is connected to a detachable plate that permits motion of the UAV within the UAV launcher assembly, showing hidden features, according to an embodiment.

FIG. 6B is a cross-sectional front view of an unmanned aerial vehicle (UAV) launcher assembly that contains a single UAV that is connected to a detachable plate that permits motion of the UAV within the UAV launcher assembly, according to an embodiment.

FIG. 7A is an isometric view of an unmanned aerial vehicle (UAV) launcher assembly that contains a single UAV having a set of wheels that permits motion of the UAV within the UAV launcher assembly, showing hidden features, according to an embodiment.

FIG. 7B is a top view of an unmanned aerial vehicle (UAV) launcher assembly that contains one or more UAVs having a set of wheels that permits motion of the UAV within the UAV launcher assembly, according to an embodiment.

FIG. 8A is an isometric view of an unmanned aerial vehicle (UAV) launcher assembly, that contains a UAV, having a contraption that permits motion of the UAV within the UAV launcher assembly, showing hidden features, according to an embodiment.

FIG. 8B is a top view of an unmanned aerial vehicle (UAV) launcher assembly, that contains a UAV, having a contraption that permits motion of the UAV within the UAV launcher assembly, showing hidden features, according to an embodiment.

FIG. 9A is a side view of a tilted unmanned aerial vehicle (UAV) launcher assembly having therein a UAV and showing hidden features, according to an embodiment.

FIG. 9B is a side isometric view of a tilted unmanned aerial vehicle (UAV) launcher assembly having therein a UAV and showing hidden features, according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

An unmanned aerial vehicle (UAV) launcher assembly is disclosed. The UAV launcher assembly includes a container having an open upper end and a bottom end. The container is adapted to accept therein one or more UAVs. The UAV launcher assembly further includes at least one fixture extending from the bottom end of the container towards the upper end of the container, the fixture, accordingly, having a height equal, or approximately equal, to the distance separating the bottom end of the container and the upper end of the container. The fixture is adapted to be accepted by at least one corresponding element of a UAV. The at least one fixture is adapted to allow motion of the UAV within the container such that the UAV can be safely launched from the container.

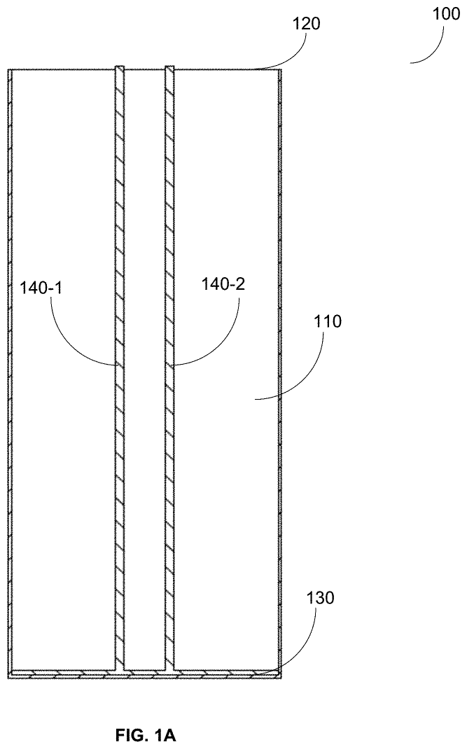

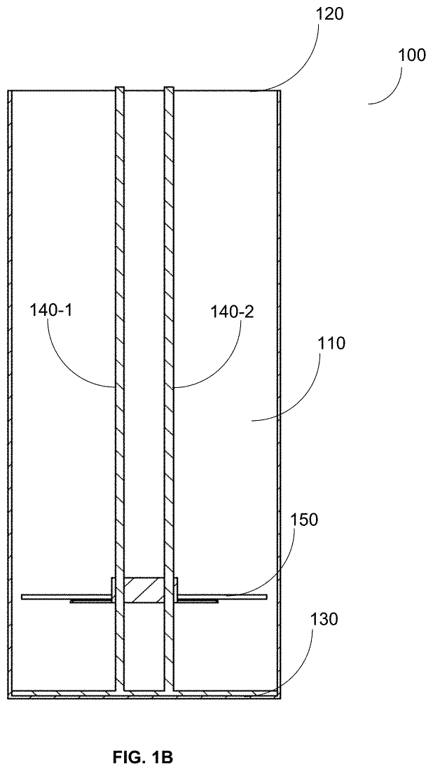

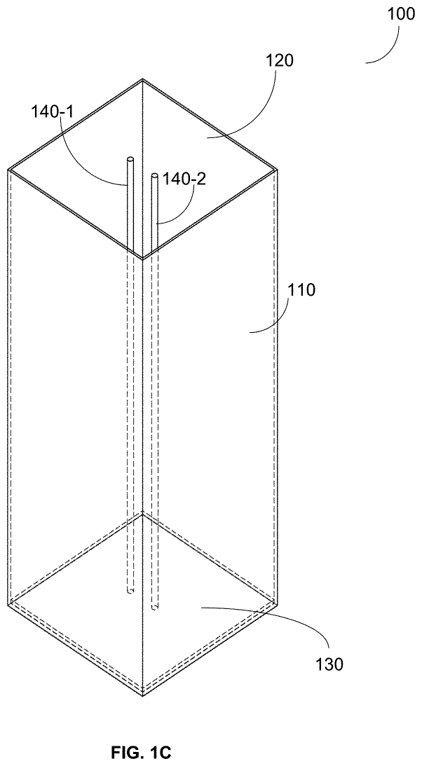

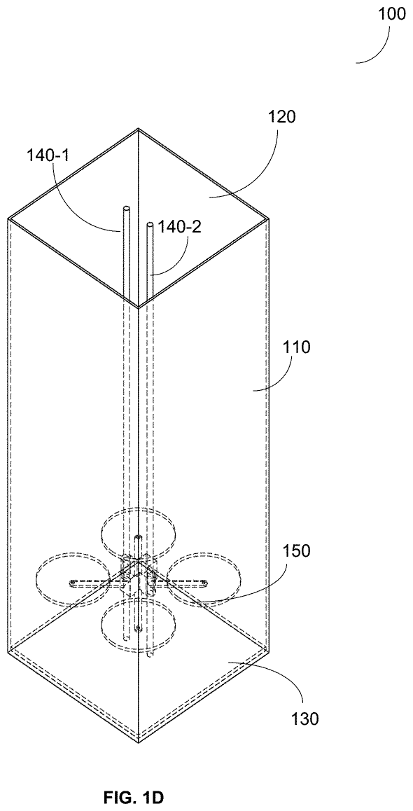

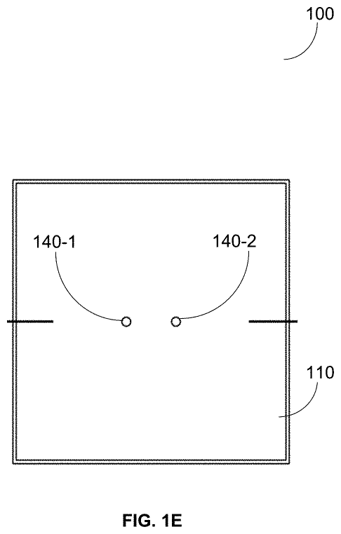

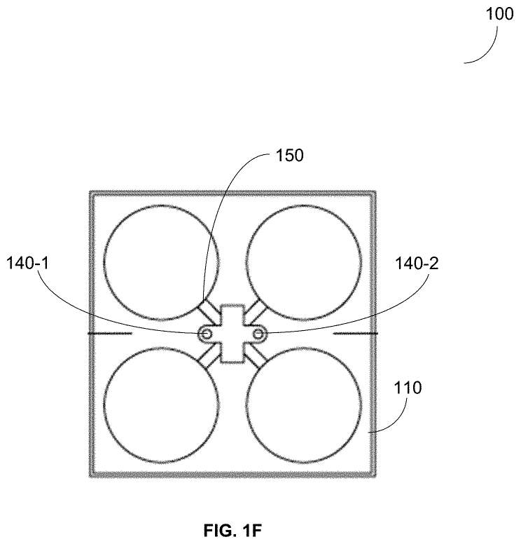

FIGS. 1A-1F show different views of an unmanned aerial vehicle (UAV) launcher assembly 100, according to an embodiment. In FIGS. 1A-1F, broken lines are used to depict hidden features inside of the assembly 100. FIG. 1A is a cross-sectional front view of an unmanned aerial vehicle (UAV) launcher assembly 100, according to an embodiment. Similarly, FIG. 1B is a cross-sectional front view of an unmanned aerial vehicle (UAV) launcher assembly 100 that contains a single UAV 150, according to an embodiment.

The UAV launcher assembly 100 includes a container 110 having an open upper end 120 and a bottom end 130. The container 110 is adapted to accept therein at least one UAV 150, as shown in FIG. 1B. The UAV launcher assembly 100 further includes at least one fixture 140, such as the fixture 140-1, extending from the bottom end 130 of the container 110 towards the upper end 120 of the container 110. In an embodiment, the fixtures 140-1 and 140-2 are round rails. The at least one fixture 140 extends to at least a height of the open upper end 120 of the container 110. The at least one fixture 140 is adapted to be accepted by at least one corresponding element of a UAV (e.g., the UAV 150 of FIG. 1B). The UAV 150 may be, for example, a drone.

The at least one fixture 140 is adapted to allow motion (e.g., vertical motion) of the UAV 150 within the container 110, while preventing undesirable motion (e.g., a lateral motion) of the UAV 150 within the container 110. Such undesirable motion may damage the UAV body and/or the UAV propellers (not shown), by causing the UAV to hit the sides of the container 110, and may, therefore, cause the UAV to stop functioning properly. It should be noted that the at least one fixture 140 is configured to apply lateral force on the UAV 150, via at least one corresponding element of the UAV 150 (described hereinbelow), such that an undesirable motion, e.g., lateral motion, is prevented, and only a desirable motion (e.g., vertical motion) is performed.

The container 110 may be made of a solid material such as metal in order to protect the at least one UAV 150 when one or more UAVs are stored within the container 110. The container 110 may further include a cover (not shown) that is located on top of the open upper end 120 and which covers the container 110, such that when the UAV launcher assembly 100 is not in use, the one or more UAVs 150 that are stored within the container 110 are covered and protected.

When one or more UAVs are about to be launched from the UAV launcher assembly 100, the cover (if it exists) is removed, the UAV 150 is activated, and the UAV's propellers (not shown) start spinning and cause the UAV 150 to start moving towards the upper end 120 and outside the container 110, using the at least one fixture 140 that guides the motion of the UAV 150 through the container 110. Since the UAV 150 is guided by the at least one fixture 140, the motion of the at least one UAV within the container 110 is stable, accurate, safe, monitored, and fast. It should be noted that the at least one fixture 140 provides for keeping the UAV 150 in a desirable posture (e.g., a horizontal posture). For example, during the launch or takeoff, when the UAV 150 motor is activated and the propellers start spinning, the posture of the UAV 150 may be changed to an undesirable posture that may damage the components of the UAV or may cause the thrust which the UAV 150 generates to propel the vehicle in an undesirable direction, e.g., towards the sides of the container 110.

Using the least one fixture 140, such undesirable postures are prevented, since the at least one fixture 140 supports and guides the UAV's motion, and, therefore, enables a desirable motion within the container 110 as further discussed hereinabove and below. The desirable motion may be a predetermined motion in a certain predetermined angle.

In an embodiment, the UAV launcher assembly 100 may be mounted on a vehicle, such as a land vehicle, a watercraft, a railed vehicle, and the like, or any combination thereof. According to another embodiment, the UAV launcher assembly 100 may be mounted on a building, a fence, tower, and the like. In an embodiment, when the UAV launcher assembly 100 is mounted on a moving vehicle and a UAV is required to be launched from the vehicle while the vehicle is moving, the UAV launcher assembly 100 permits a stable, safe, and fast launch, even in extreme conditions.

FIG. 1C shows the UAV launcher assembly 100 from an outside view, according to an embodiment. FIG. 1D shows the UAV launcher assembly 100 from the same view but also showing a hidden UAV 150 inside of the UAV launcher assembly 100. FIG. 1E shows a top view of the UAV launcher assembly 100. FIG. 1F shows the top view of the UAV launcher assembly 100 including one or more UAVs 150.

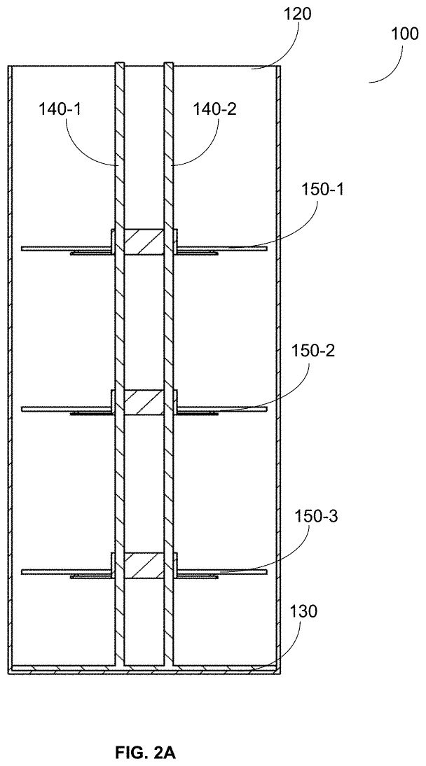

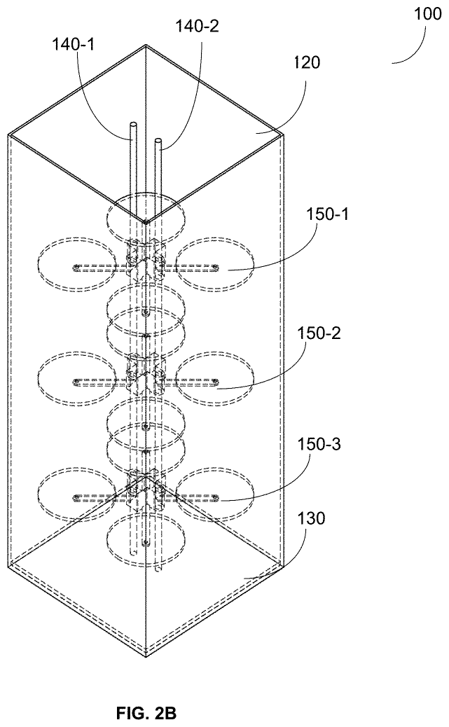

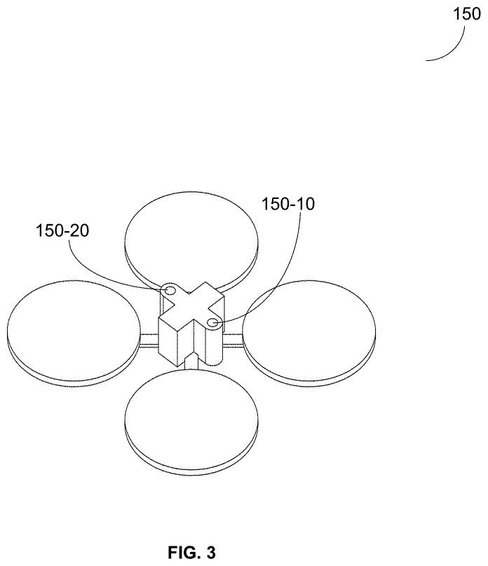

FIG. 2A shows an example cross-sectional front view of an unmanned aerial vehicle (UAV) launcher assembly 100 that contains multiple UAVs, according to an embodiment. Further, in another view, FIG. 2B shows an example isometric view of an unmanned aerial vehicle (UAV) launcher assembly 100 that contains multiple UAVs 150 showing hidden features, according to an embodiment. The UAV launcher assembly 100 may be configured to include more than one UAV at the same time. The UAV launcher assembly 100 may include therein a fleet of UAVs 150-1 through 150-3 (hereinafter referred to as a UAV 150 or as UAVs 150) that may be safely launched from the container 110. The UAVs 150 may be vertically stored within the container 110. It should be noted that each UAV 150 that is stored within the container 110 has at least one element (shown at least in FIG. 3) by which the UAV 150 is adapted to accept the at least one fixture 140 of the UAV launcher assembly 100. Thus, each UAV 150 is launched in a monitored, stable and safe manner without hitting the container.

FIG. 3 shows an example isometric view of an unmanned aerial vehicle (UAV) 150 for use with a UAV launcher assembly, where the launcher assembly comprises a container and two fixtures extending therein, according to an embodiment. The UAV 150 may include at least one element 150-10 such as a bearing, a hole, and the like, where the element 150-10 is adapted to accept at least one fixture (e.g., the fixture 140 shown in at least FIG. 1A) of the UAV launcher assembly 100 (shown in at least FIG. 1A). The example elements 150-10 and 150-20 (e.g., bearings), are further adapted to permit motion of the UAV 150 within the UAV launcher assembly 100 about the at least one fixture 140 (shown in at least FIG. 1A).

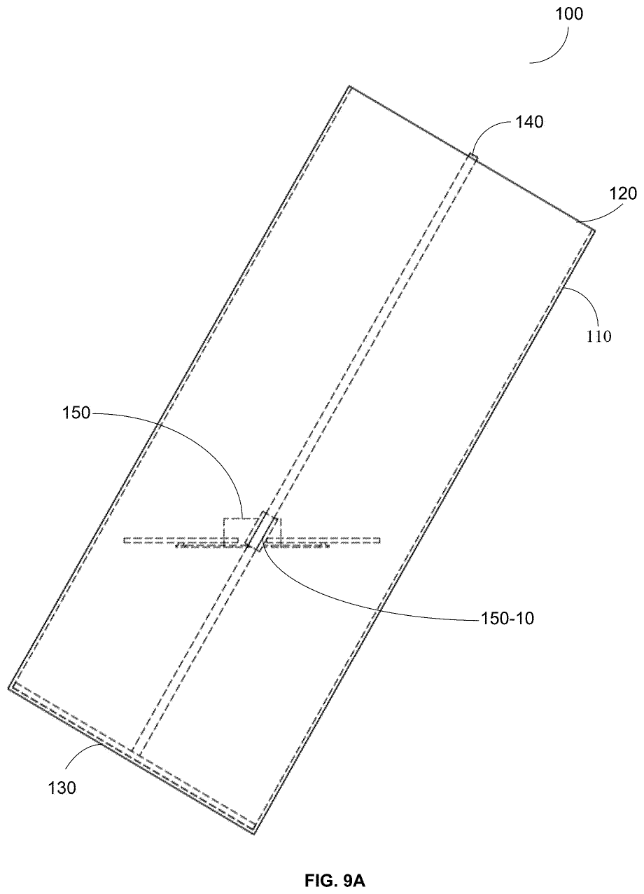

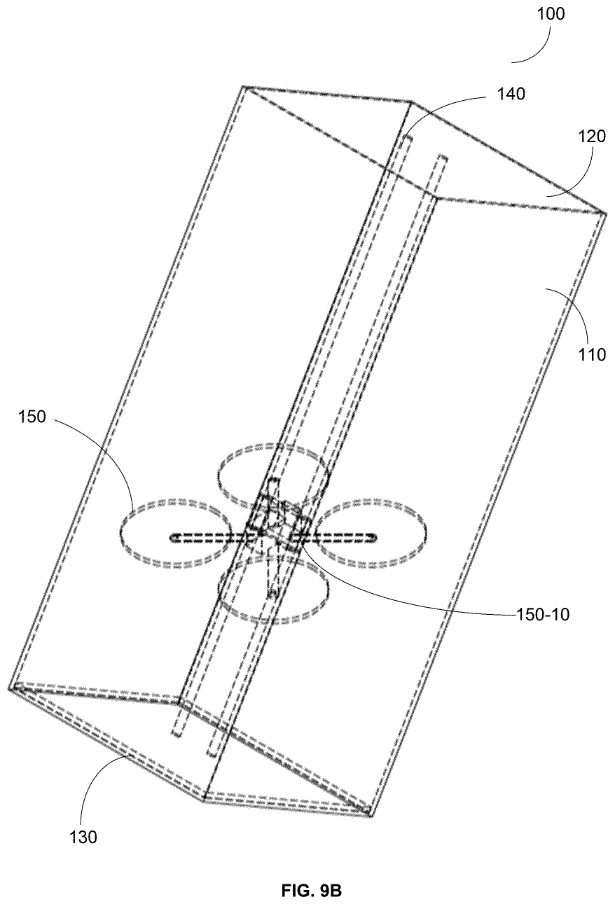

According to another embodiment, the at least one element, e.g., the elements 150-10 and 150-20, may be an integral component of the UAV 150 or may be connected to the UAV 150 using one or more mechanisms (not shown). Each of the example elements 150-10 and 150-20 may be a tilting element. Such tilting elements are adapted such that the UAV 150, when the elements accept the at least one fixture 140 (shown in FIG. 1A), keeps a certain posture, e.g., a horizontal posture, even when the container 110 tilts in a certain angle. An example for such tilting of the container 110 is shown in FIGS. 9A and 9B. It should be noted that the posture of the container 110, and the posture of the UAV 150 within it, can be adjusted according to multiple considerations. The disclosure describes a system by which the UAV 150 is kept in a desirable posture before leaving the container 110.

In reference to FIGS. 9A and 9B, FIG. 9A is an example side view of a tilted unmanned aerial vehicle (UAV) launcher assembly 100 having therein a UAV 150 and showing hidden features, according to an embodiment. Similarly, FIG. 9B is a side isometric view of a tilted unmanned aerial vehicle (UAV) launcher assembly 100 having therein a UAV 150 and showing hidden features, according to an embodiment.

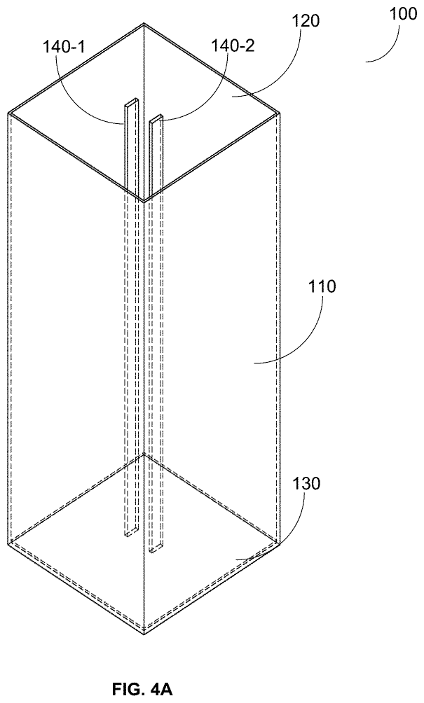

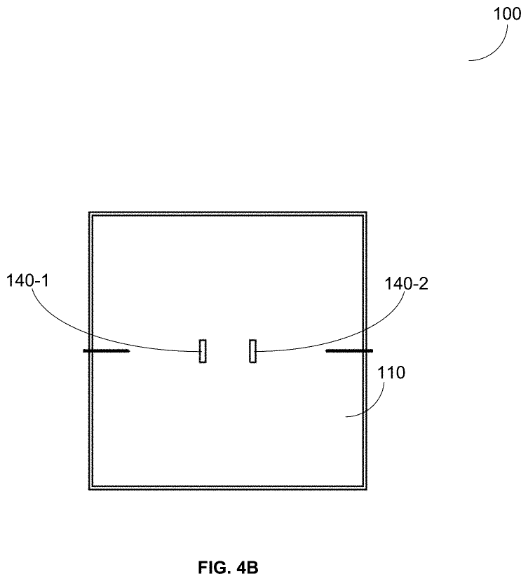

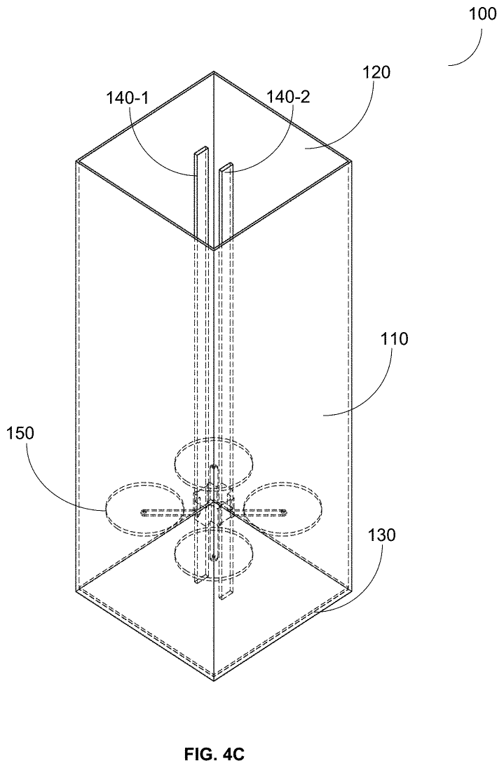

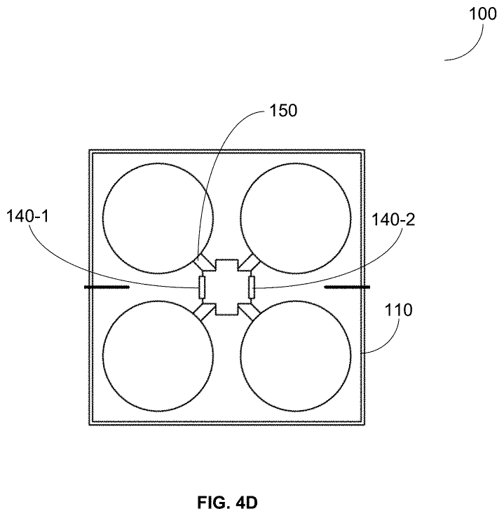

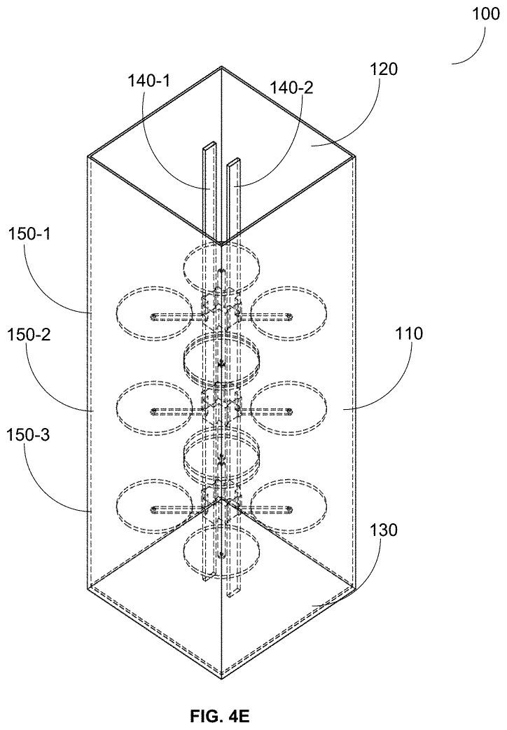

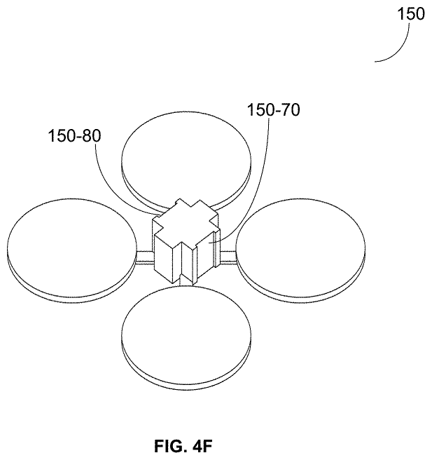

Reference is now made to FIGS. 4A-4D. FIG. 4A shows an example cross-sectional isometric view of an unmanned aerial vehicle (UAV) launcher assembly 100 having two square guide rails 140-1 and 140-2 and showing hidden features, according to an embodiment. Similarly, FIG. 4B is an example top view of an unmanned aerial vehicle (UAV) launcher assembly 100 having two square guide rails 140-1 and 140-2, according to an embodiment. Likewise, FIG. 4C is an example isometric view of an unmanned aerial vehicle (UAV) launcher assembly 100, having two square guide rails 140-1 and 140-2, that contains a single UAV 150, showing hidden features, according to an embodiment. Further, FIG. 4D is an example top view of an unmanned aerial vehicle (UAV) launcher assembly 100, having two square guide rails 140-1 and 140-2, that contains one or more UAVs 150, according to an embodiment. In FIGS. 4A-4D, broken lines are used to depict hidden features inside of the assembly 100.

In an embodiment, the UAV launcher assembly 100 that is shown in at least FIGS. 1A-1F may include a plurality of square guide rails 140-1 and 140-2. For example, the square rails 140-1 and 140-2 are shown in FIG. 4A. That is, the at least one fixture 140 extending from the bottom end 130 of the container 110 towards the upper end 120 of the container 110 may be implemented as the square guide rails 140-1 and 140-2 shown in FIG. 4A. The square guide rails 140-1 and 140-2 extend to at least a height of the open upper end 120 of the container 110. The square rails 140-1 and 140-2 are adapted to be accepted by at least one corresponding element (e.g., the elements 150-70 and 150-80 shown in FIG. 4F) of at least one UAV, such as the UAV 150. The square guide rails 140-1 and 140-2 are adapted to allow a motion (e.g., a vertical motion) of at least one UAV 150 within the container.

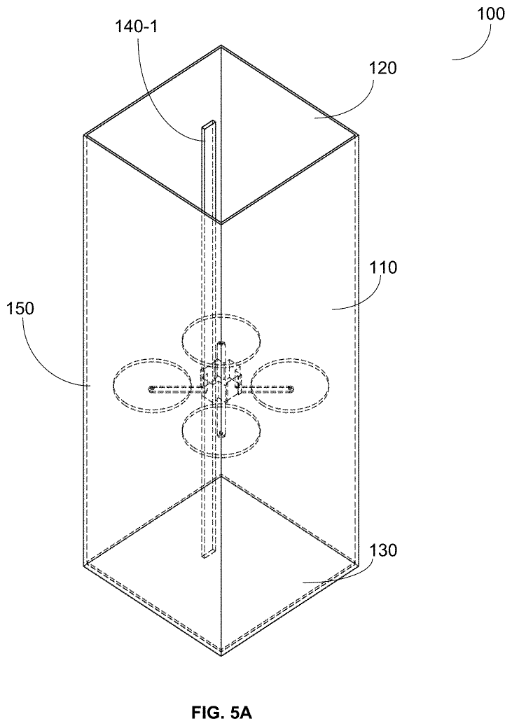

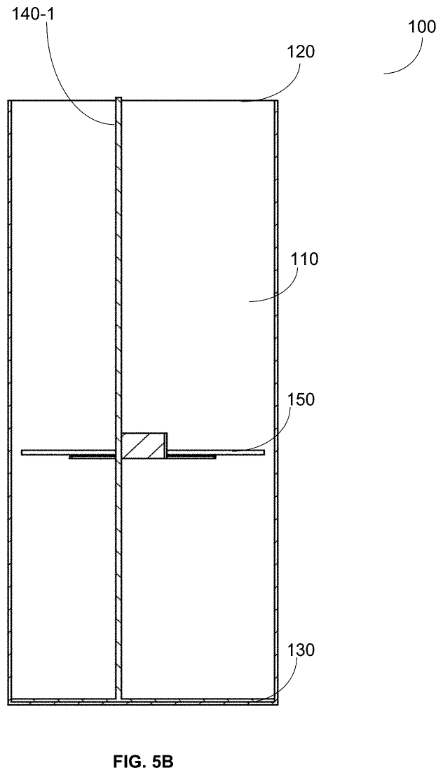

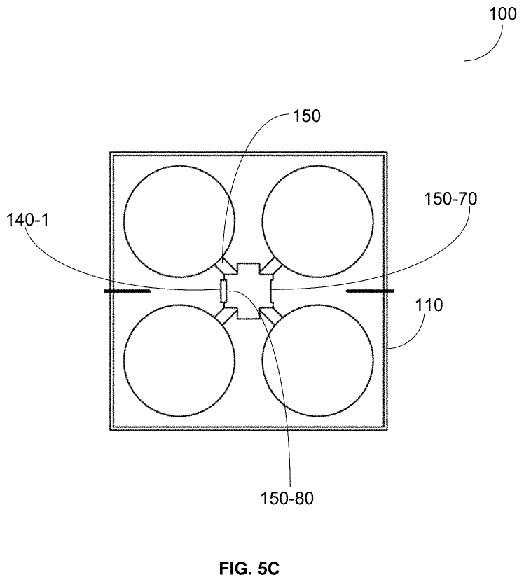

In an embodiment, the UAV launcher assembly 100 may include a single square guide rail (i.e., the fixture 140), such as the square guide rail 140 shown in FIG. 5A. According to the same embodiment, and as shown in FIGS. 5A-5C, wherein the UAV launcher assembly 100 has a single square guide rail 140-1, the one or more UAVs 150, which are stored within the UAV launcher assembly 100, may include one or more slots such as, for example, square bearings, including, without limitation, the square bearings 150-70 and 150-80, or the like. Thus, one of the square bearings, for example the square bearing 150-80, is adapted to accept the single square guide rail (e.g., the single square guide rail 140-1).

In reference to FIGS. 5A-5C, wherein the UAV launcher assembly 100 has a single square guide rail 140-1, FIG. 5A is an example isometric view of an unmanned aerial vehicle (UAV) launcher assembly 100, having a single square guide rail 140-1, that contains a single UAV 150, showing hidden features, according to an embodiment. Similarly, FIG. 5B is an example cross-sectional front view of an unmanned aerial vehicle (UAV) launcher assembly 100, having a single square guide rail 140-1, that contains a single UAV 150, according to an embodiment. Likewise, FIG. 5C is an example top view of an unmanned aerial vehicle (UAV) launcher assembly 100, having a single square guide rail 140-1, that contains a single UAV 150, according to an embodiment.

Reference is now made to FIG. 4E, which shows an example cross-sectional isometric view of an unmanned aerial vehicle (UAV) launcher assembly 100, having at least two square guide rails, that contains multiple UAVs. In FIG. 4E, broken lines are used to depict hidden features inside of the assembly 100. In an embodiment, the UAV launcher assembly 100 may be configured to include more than one UAV, such as UAVs 150-1 through 150-3, at the same time. The UAV launcher assembly 100 may include therein a fleet of UAVs that may be safely launched from the container 110. The UAVs may be vertically stored within the container 110. It should be noted that each UAV 150 that is stored within the container 110 has at least one element (shown at least in FIG. 4F) by which the UAV is adapted to accept, for example, the two square guide rails (i.e., the fixture 140) of the UAV launcher assembly 100. Thus, each UAV (e.g., the UAV 150) is launched in a monitored, stable, and safe manner without hitting the container.

FIG. 4F shows an example isometric view of an unmanned aerial vehicle (UAV) 150 having two slots for use with a UAV launcher assembly that comprises a container and at least one fixture extending therein. In an embodiment, the UAV 150 may include at least one element such as a square bearing, a square open bearing, and so on. As a non-limiting example, the square bearings 150-70 and 150-80 are adapted to accept at least one fixture (e.g., the fixture 140 shown in at least FIG. 4A) of the UAV launcher assembly 100 (shown at least FIG. 4A). The square bearings 150-70 and 150-80 (e.g., the elements), are further adapted to permit motion of the UAV 150 within the UAV launcher assembly 100 about the at least one fixture 140 (shown in at least FIG. 4A).

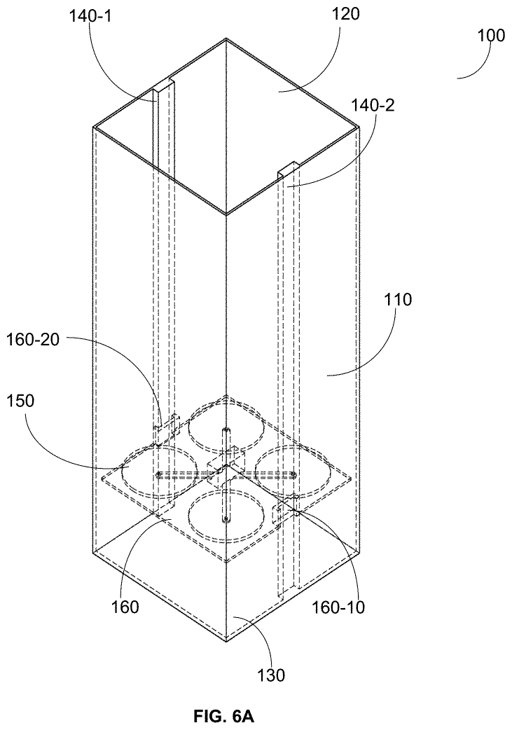

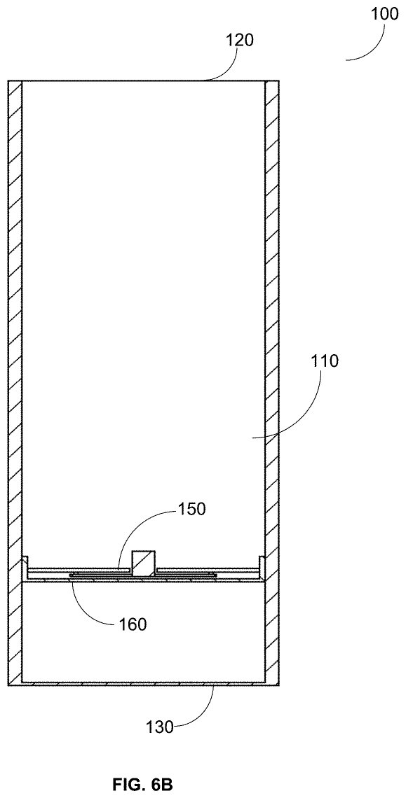

FIGS. 6A-6B show example views of an unmanned aerial vehicle (UAV) launcher assembly 100 that contains a single UAV 150 that is connected to a detachable plate 160 that permits motion of the UAV 150 within the UAV launcher assembly 100. Specifically, FIG. 6A is an example isometric view of an unmanned aerial vehicle (UAV) launcher assembly 100 that contains a single UAV 150 that is connected to a detachable plate 160 that permits motion of the UAV 150 within the UAV launcher assembly 100, showing hidden features, according to an embodiment. Similarly, FIG. 6B is an example cross-sectional front view of an unmanned aerial vehicle (UAV) launcher assembly 100 that contains a single UAV 150 that is connected to a detachable plate 160 that permits motion of the UAV 150 within the UAV launcher assembly 100, according to an embodiment. In FIGS. 6A-6B, broken lines are used to depict hidden features inside of the assembly 100.

In an embodiment, a UAV, such as the UAV 150, may be attached to a plate 160 having one or more elements (e.g., the elements 160-10 and 160-20) that are adapted to accept the at least one fixture 140 (e.g., square guide rails, round guide rails, one or more poles, and on the like) of the UAV launcher assembly 100. The example elements 160-10 and 160-20 are adapted to accept the at least one fixture 140 of the UAV launcher assembly 100. The elements 160-10 and 160-20 are further adapted to permit motion of the UAV 150 within the UAV launcher assembly 100 about the at least one fixture 140. The UAV 150 and the plate 160 may be physically connected through a magnetic mechanism (not shown), a mechanical mechanism (not shown), or the like. In an embodiment, when the UAV 150 reaches a predetermined height, or reaches a predetermined position with respect to the container 110, the plate 160 and the UAV 150 split up such that the plate 160 falls down to the ground and the UAV 150 continues to fly without the plate 160.

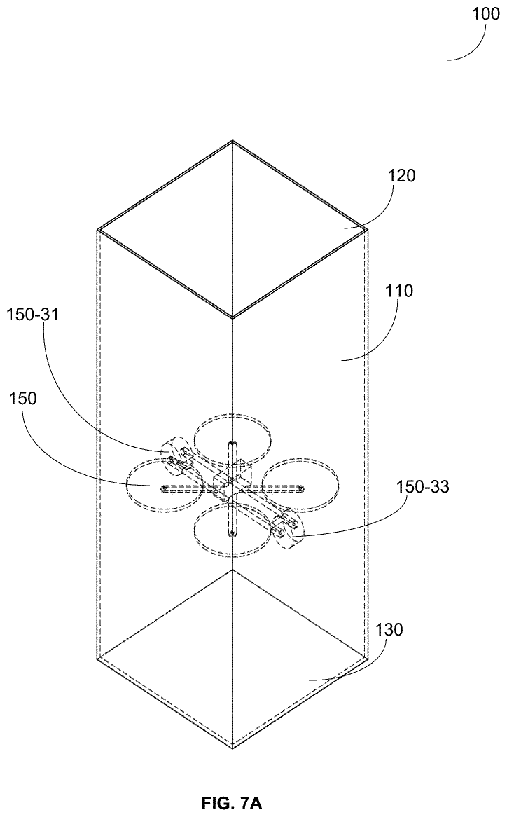

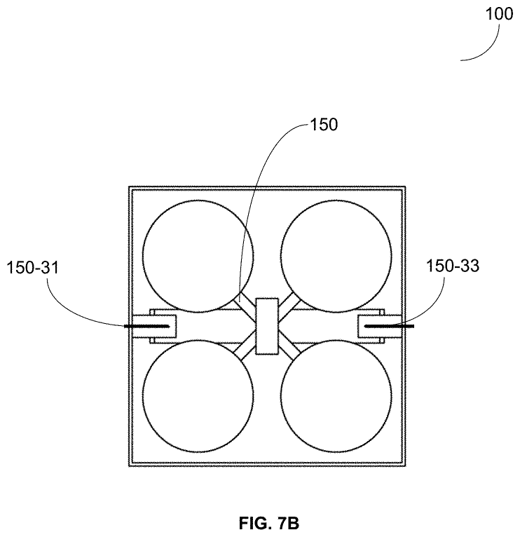

FIGS. 7A-7B show example views of an unmanned aerial vehicle (UAV) launcher assembly 100 that contains a UAV 150 having a set of wheels 150-31 and 150-33 that permits motion of the UAV 150 within the UAV launcher assembly 100. Specifically, FIG. 7A is an example isometric view of an unmanned aerial vehicle (UAV) launcher assembly 100 that contains a single UAV 150 having a set of wheels 150-31 and 150-33 that permits motion of the UAV 150 within the UAV launcher assembly 100, showing hidden features, according to an embodiment. Similarly, FIG. 7B is an example top view of an unmanned aerial vehicle (UAV) launcher assembly 100 that contains one or more UAVs 150 having a set of wheels 150-31 and 150-33 that permits motion of the UAV 150 within the UAV launcher assembly 100, according to an embodiment. In FIGS. 7A-7B, broken lines are used to depict hidden features inside of the assembly 100.

In an embodiment, the UAV 150 includes a set of wheels 150-31 and 150-33 that is attached to the UAV 150. Each wheel of the set of wheels 150-31 and 150-33 may be in contact with the container 110 such that the set of wheels 150-31 and 150-33 permits motion of the UAV 150 within the UAV launcher assembly 100. In an embodiment, when the UAV 150 is activated, the UAV's propellers (not shown) start spinning and cause the UAV 150 to start moving towards the upper end 120 and outside the container 110, using the set of wheels 150-31 and 150-33 that guides the motion of the UAV 150 through the container 110. Since the UAV 150 is guided by the set of wheels 150-31 and 150-33, the motion of the at least one UAV 150 within the container 110 is stable, safe, monitored, and fast. In an embodiment, the UAV 150 may include a folding mechanism (not shown) that automatically folds the set of wheels 150-30 after the UAV 150 reaches a predetermined position, height, distance, or the like.

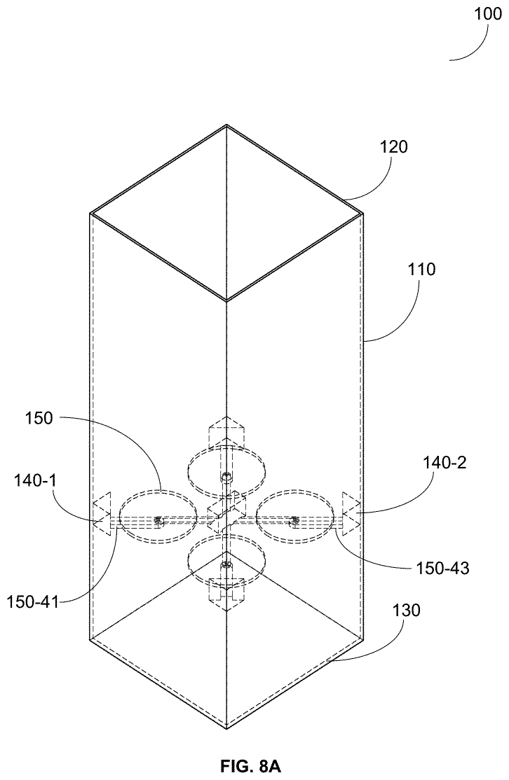

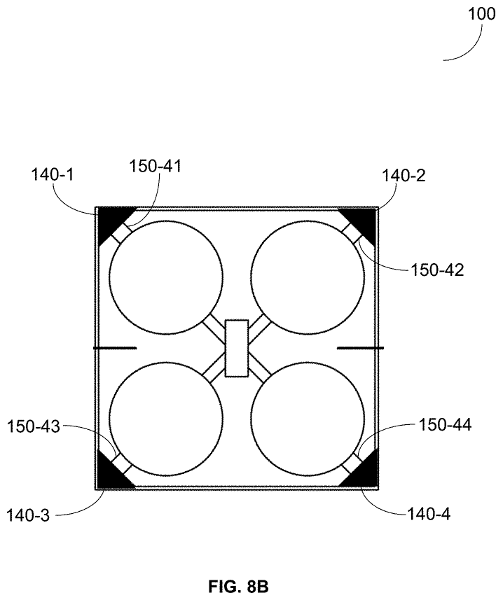

Reference is now made to FIGS. 8A and 8B. According to one embodiment, the UAV launcher assembly 100 includes a set of fixtures 140 (e.g., a set of guide rails 140), that are located, for example, at the internal sides, corners, etc. of the container 110. Specifically, FIG. 8A is an example isometric view of an unmanned aerial vehicle (UAV) launcher assembly 100, that contains a UAV 150, having an element 150-41 and 150-43 that permits motion of the UAV 150 within the UAV launcher assembly 100, showing hidden features, according to an embodiment. Similarly, FIG. 8B is an example top view of an unmanned aerial vehicle (UAV) launcher assembly 100, that contains a UAV 150, having an element 150-41 through 150-44 that permits motion of the UAV 150 within the UAV launcher assembly 100, showing hidden features, according to an embodiment.

According to another embodiment, a UAV such as the UAV 150, includes at least one element 150-40 adapted to accept the at least one fixture 140 (e.g., the one or more guide rails 140) of the UAV launcher assembly 100. The at least one element 150-40 may be, for example, a set of open bearings (e.g., the bearings 150-41 through 150-44 that are shown in FIGS. 7A and 7B) that are adapted to permit motion of the UAV 150 within the UAV launcher assembly 100 about, for example, the one or more guide rails 140 (i.e., the at least one fixture 140).

All examples and conditional language recited herein are intended for pedagogical purposes to aid the reader in understanding the principles of the disclosure and the concepts contributed by the inventor to furthering the art and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

What is claimed is:

1. An unmanned aerial vehicle (UAV) launcher assembly, the UAV launcher assembly comprising:
a container having an open upper end and a bottom end, wherein the container is adapted to accept therein at least one UAV, wherein the bottom end is separated from the open upper end by a distance; and
at least one fixture extending from the bottom end of the container towards the open upper end of the container, wherein the at least one fixture extends to at least a height equal to the distance separating the bottom end of the container from the open upper end of the container, wherein the at least one fixture is adapted to be accepted by at least one corresponding element of the at least one UAV, and wherein the at least one fixture is adapted to allow vertical motion of the at least one UAV within the container.

2. The assembly of claim 1, wherein the at least one fixture is adapted to apply lateral force on the at least one UAV via the at least one corresponding element.

3. The assembly of claim 2, wherein the applied lateral force allows for stabilization of the motion of the UAV within the container.

4. The assembly of claim 1, wherein the at least one fixture is adapted to hold the UAV in a predetermined posture.

5. The assembly of claim 1, wherein each of the at least one fixture is a rail having a rectangular cross-section.

6. The assembly of claim 1, wherein the assembly further comprises:
at least one detachable plate, wherein each detachable plate is adapted to attach to one of the at least one UAV, wherein each detachable plate is adapted to accept the at least one fixture of the assembly, and wherein the at least one detachable plate is adapted to separate from the respective UAV of the at least one UAV.

7. An unmanned aerial vehicle (UAV) for use with a UAV launcher assembly that comprises a container and at least one fixture extending therein, the UAV comprising:
at least one element adapted to accept the at least one fixture of the UAV launcher assembly, wherein the at least one element is further adapted to permit motion of the UAV within the UAV launcher assembly about the at least one fixture.

8. The UAV of claim 7, wherein the at least one element is a tilting element.

9. The UAV of claim 8, wherein the tilting element keeps the UAV in a predetermined posture within the container.

10. The UAV of claim 7, wherein the at least one element is an integral component of the UAV.

11. The UAV of claim 7, wherein the at least one element is an external component affixed to the UAV.

12. The UAV of claim 7, wherein the at least one element includes at least one slot adapted to accept the at least one fixture of the UAV launcher assembly.

13. The UAV of claim 7, wherein the UAV further comprises:
at least one wheel, wherein the at least one wheel is adapted to permit motion of the UAV within the UAV launcher assembly.

14. The UAV of claim 13, wherein the at least one wheel is adapted to guide the UAV within the UAV launcher assembly.
